(19) United States
(12) Patent Application Publication
(10) Pub. No.: US 2022/0012001 A1
(43) Pub. Date: Jan. 13, 2022

(54) METHOD AND APPARATUS FOR IMPLEMENTING AN APPLICATION AGNOSTIC FRAMEWORK MODULE

(71) Applicant: JPMorgan Chase Bank, N.A., New York, NY (US)

(72) Inventor: Dave FETZER, Chicago, IL (US)

(73) Assignee: JPMorgan Chase Bank, N.A., New York, NY (US)

(21) Appl. No.: 17/305,549

(22) Filed: Jul. 9, 2021

Related U.S. Application Data
(60) Provisional application No. 63/049,796, filed on Jul. 9, 2020.

(51) Int. Cl. G06F 3/14; G06F 3/0484; G06F 16/21

(52) U.S. Cl. CPC G06F 3/1423; G06F 13/4282; G06F 16/212; G06F 3/0484

(57) ABSTRACT

Various methods, apparatuses/systems, and media for an application agnostic framework module are disclosed. A plurality of display devices are provided, each display device being configured with a web-based application configured with an endpoint listener. Each display device is configured to listen for a specific configured location via corresponding endpoint listener. A receiver receives location specific information of input data corresponding to the specific configured location. The web-based application connects to each endpoint listener for said specific configured location. A processor defines a schema for publishing information onto each display device based on the location specific information of input data. A monitor displays information onto each display device based on the defined schema. The processor refreshes ONA (Organizational Network Analysis) data corresponding to the web-based application on a regular basis.

### CROSS-REFERENCE TO RELATED APPLICATIONS

This application claims the benefit of priority from U.S. Provisional Patent Application No. 63/049,796, filed Jul. 9, 2020, which is herein incorporated by reference in its entirety.

### TECHNICAL FIELD

This disclosure generally relates to data processing, and, more particularly, to methods and apparatuses for implementing an application agnostic framework module that may allow publication of received information onto a display that may be automatically customizable based on location specific criteria for display.

### BACKGROUND

The developments described in this section are known to the inventors. However, unless otherwise indicated, it should not be assumed that any of the developments described in this section qualify as prior art merely by virtue of their inclusion in this section, or that those developments are known to a person of ordinary skill in the art.

Conventional visualization tools lack a framework to identify problematic behaviors or trends in an application through the use of location specific cloud-based visualizations in high performance workspaces.

### SUMMARY

The present disclosure, through one or more of its various aspects, embodiments, and/or specific features or sub-components, may provide, among others, various systems, servers, devices, methods, media, programs, and platforms for implementing an application agnostic framework module for identifying problematic behaviors or trends in an application through the use of location specific cloud-based visualizations in high performance workspaces, but the disclosure is not limited thereto. The present disclosure, through one or more of its various aspects, embodiments, and/or specific features or sub-components, may also provide, among others, various systems, servers, devices, methods, media, programs, and platforms for implementing an application agnostic framework module that may allow publication of location specific received information onto a display that may be customizable based location specific criteria for display. The present disclosure, through one or more of its various aspects, embodiments, and/or specific features or sub-components, may also provide, among others, various systems, servers, devices, methods, media, programs, and platforms for implementing an application agnostic framework module for a cloud-based application that includes REST (Representational State Transfer)-based end points where consumers may post KPI (Key Performance Indicator) or relevant metrics, thereby allowing visual cues on how the application may be performing over a course of a day, but the disclosure is not limited thereto.

According to an aspect of the present disclosure, a method for implementing an application agnostic framework module by utilizing one or more processors and one or more memories is disclosed. The method may include: providing a plurality of display devices, each display device being configured with a web-based application configured with an endpoint listener, wherein each display device is configured to listen for a specific configured location via corresponding endpoint listener; receiving location specific information of input data corresponding to the specific configured location, wherein the web-based application connects to each endpoint listener for said specific configured location; defining a schema for publishing information onto each display device based on the location specific information of input data; and displaying information onto each display device based on the defined schema.

According to another aspect of the present disclosure, the method may further include: refreshing ONA (Organizational Network Analysis) data corresponding to the web-based application on a regular basis.

According to yet another aspect of the present disclosure, the method may further include: receiving user's input to customize each endpoint listener based on location data of corresponding display device.

According to an additional aspect of the present disclosure, wherein the displaying information onto each display device based on the defined schema comprises publishing information based on one or more of the following data: a name data, a value data, a combination of a name and a value data, a desired display style or format data, a desired display location data, a data of desired display position onto a monitor of each display device in each display location, but the disclosure is not limited thereto.

According to further aspect of the present disclosure, the method may further include: providing a framework that is agnostic to the data being passed, wherein the schema is a JSON schema, and within rules of said JSON schema, transmitting the publishing information from a user's computing device, who is requesting publication of the information onto a desired display device, to the web-based application.

According to an additional aspect of the present disclosure, wherein the web-based application includes REST (Representational State Transfer)-based endpoints each configured to receive user's input for posting KPI (Key Performance Indicator) or relevant metrics for displaying information onto each display device based on the received user's input.

According to yet another aspect of the present disclosure, the method may further include: customizing the endpoints based on the received location specific information of input data; and pushing the endpoints to the display device meeting the received location specific information of input data that is displaying the web-based application that consumes the metrics.

According to an additional aspect of the present disclosure, wherein the received location specific information of input data is utilized as coordinates for the metrics.

According to a further aspect of the present disclosure, the method may further include: connecting a Raspberry Pi or a USB (Universal Serial Bus) device onto each display device configured to listen for the specific configured location via corresponding endpoint listener.

According to an aspect of the present disclosure, a system for implementing an application agnostic framework module is disclosed. The system may include: a processor, a memory, a plurality of display devices, and a communication network coupled to each of the processor, the memory, and the plurality of display devices, wherein each display device being configured with a web-based application configured with an endpoint listener, wherein each display device is configured to listen for a specific configured location via corresponding endpoint listener. The processor may be configured to: receive location specific information of input data corresponding to the specific configured location, wherein the web-based application connects to each endpoint listener for said specific configured location; define a schema for publishing information onto each display device based on the location specific information of input data; and display information onto each display device based on the defined schema.

According to another aspect of the present disclosure, the processor may be further configured to: refresh ONA (Organizational Network Analysis) data corresponding to the web-based application on a regular basis.

According to yet another aspect of the present disclosure, the processor may be further configured to: receive user's input to customize each endpoint listener based on location data of corresponding display device.

According to an additional aspect of the present disclosure, wherein in displaying information onto each display device based on the defined schema, the processor may be further configured to publish information based on one or more of the following data: a name data, a value data, a combination of a name and a value data, a desired display style or format data, a desired display location data, a data of desired display position onto a monitor of each display device in each display location, but the disclosure is not limited thereto.

According to further aspect of the present disclosure, the processor may configure a framework that is agnostic to the data being passed, wherein the schema is a JSON schema, and within rules of said JSON schema, transmit the publishing information from a user's computing device, who is requesting publication of the information onto a desired display device, to the web-based application.

According to yet another aspect of the present disclosure, the processor may be further configured to: customize the endpoints based on the received location specific information of input data; and push the endpoints to the display device meeting the received location specific information of input data that is displaying the web-based application that consumes the metrics.

According to an additional aspect of the present disclosure, the processor may be further configured to utilize the received location specific information of input data as coordinates for the metrics.

According to a further aspect of the present disclosure, the processor may be further configured to: connect a Raspberry Pi or a USB (Universal Serial Bus) device onto each display device configured to listen for the specific configured location via corresponding endpoint listener.

According to an aspect of the present disclosure, non-transitory computer readable medium configured to store instructions for implementing an application agnostic framework module is disclosed. The instructions, when executed, may cause a processor to perform the following: configuring a plurality of display devices, each display device being configured with a web-based application configured with an endpoint listener, wherein each display device is configured to listen for a specific configured location via corresponding endpoint listener; receiving location specific information of input data corresponding to the specific configured location, wherein the web-based application connects to each endpoint listener for said specific configured location; defining a schema for publishing information onto each display device based on the location specific information of input data; and displaying information onto each display device based on the defined schema.

According to another aspect of the present disclosure, the instructions, when executed, may further cause the processor to perform the following: refreshing ONA (Organizational Network Analysis) data corresponding to the web-based application on a regular basis.

According to yet another aspect of the present disclosure, the instructions, when executed, may further cause the processor to perform the following: receiving user's input to customize each endpoint listener based on location data of corresponding display device.

According to an additional aspect of the present disclosure, wherein in displaying information onto each display device based on the defined schema, the instructions, when executed, may further cause the processor to publish information based on one or more of the following data: a name data, a value data, a combination of a name and a value data, a desired display style or format data, a desired display location data, a data of desired display position onto a monitor of each display device in each display location, but the disclosure is not limited thereto.

According to further aspect of the present disclosure, the instructions, when executed, may further cause the processor to perform the following: configuring a framework that is agnostic to the data being passed, wherein the schema is a JSON schema, and within rules of said JSON schema, transmitting the publishing information from a user's computing device, who is requesting publication of the information onto a desired display device, to the web-based application.

According to yet another aspect of the present disclosure, the instructions, when executed, may further cause the processor to perform the following: customizing the endpoints based on the received location specific information of input data; and pushing the endpoints to the display device meeting the received location specific information of input data that is displaying the web-based application that consumes the metrics.

According to an additional aspect of the present disclosure, the instructions, when executed, may further cause the processor to utilize the received location specific information of input data as coordinates for the metrics.

According to a further aspect of the present disclosure, the instructions, when executed, may further cause the processor to perform the following: connecting a Raspberry Pi or a USB (Universal Serial Bus) device onto each display device configured to listen for the specific configured location via corresponding endpoint listener.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing an application agnostic framework module in accordance with an exemplary embodiment.

FIG. 2 illustrates an exemplary network diagram of an application agnostic framework device in accordance with an exemplary embodiment.

FIG. 3 illustrates a system diagram for implementing an application agnostic framework device with an application agnostic framework module in accordance with an exemplary embodiment.

FIG. 4 illustrates a system diagram for implementing an application agnostic framework module of FIG. 3 in accordance with an exemplary embodiment.

FIG. 5A illustrates an exemplary use case of an application agnostic framework module in accordance with an exemplary embodiment.

FIG. 5B illustrates another exemplary use case of an application agnostic framework module in accordance with an exemplary embodiment.

FIG. 6 illustrates a flow chart for implementing an application agnostic framework module in accordance with another exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, mechanism, units, engines, tools, devices and/or modules. Those skilled in the art will appreciate that these blocks, units, engines, tools, devices, and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, engines, tools, devices, and/or modules being implemented by microprocessors or similar, they may be programmed using software (e.g., microcode) to perform various functions discussed herein and may optionally be driven by firmware and/or software. Alternatively, each block, unit, engine, tool device, and/or module may be implemented by dedicated hardware, or as a combination of dedicated hardware to perform some functions and a processor (e.g., one or more programmed microprocessors and associated circuitry) to perform other functions. Also, each block, unit, engine, tool, device, and/or module of the example embodiments may be physically separated into two or more interacting and discrete blocks, units, engines, tools, devices, and/or modules without departing from the scope of the inventive concepts. Further, the blocks, units, engines, tools, devices, and/or modules of the example embodiments may be physically combined into more complex blocks, units, engines, tools, devices, and/or modules without departing from the scope of the present disclosure.

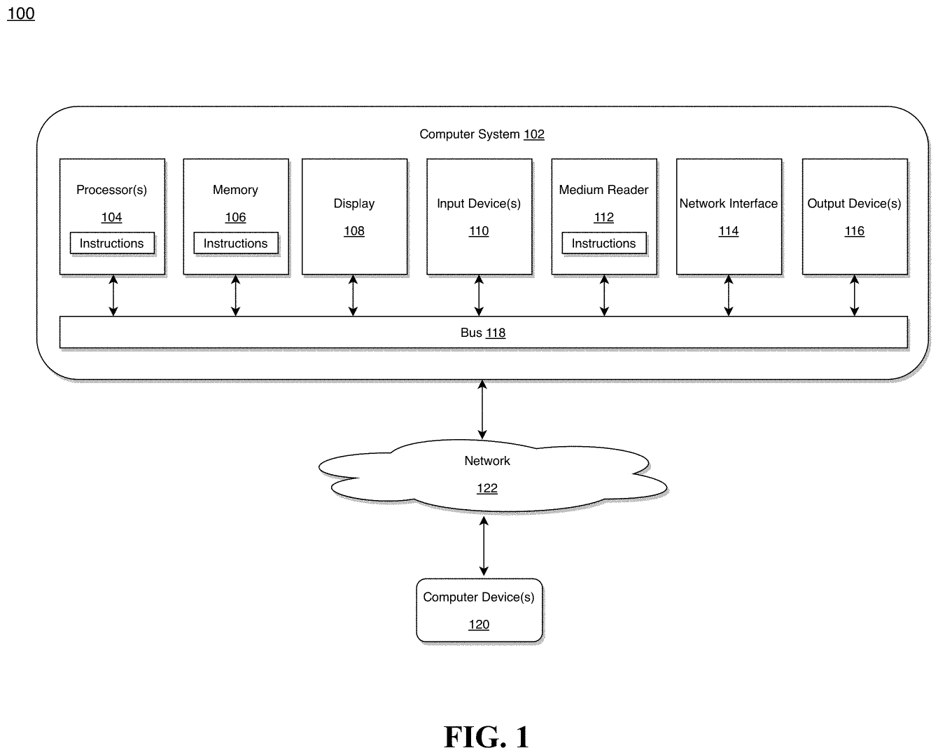

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

As described herein, various embodiments provide optimized processes of implementing an application agnostic framework module for identifying problematic behaviors or trends in an application through the use of location specific cloud-based visualizations in high performance workspaces, but the disclosure is not limited thereto.

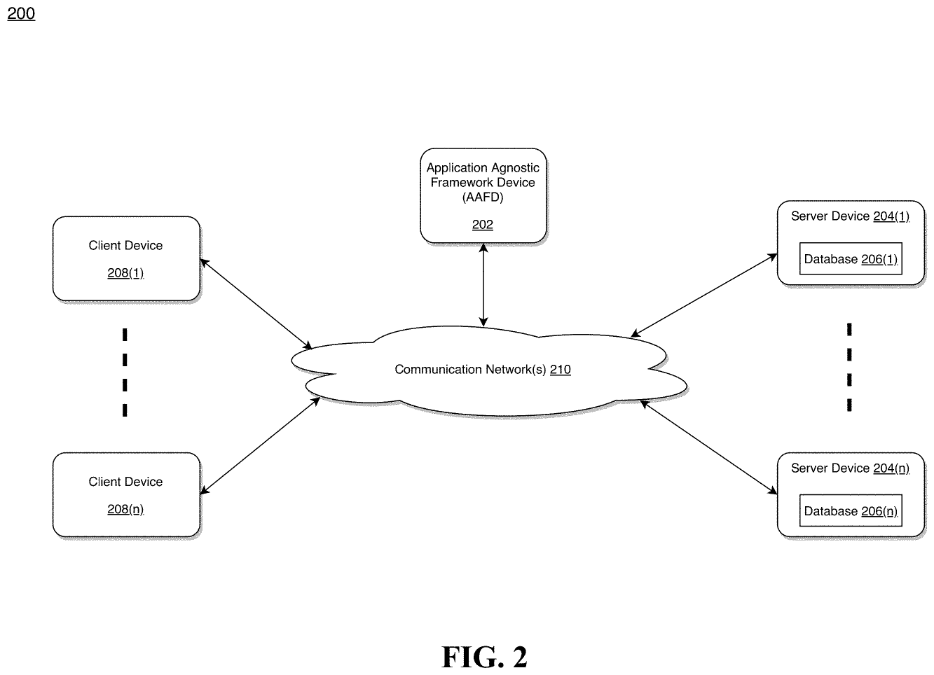

Referring to FIG. 2, a schematic of an exemplary network environment 200 for implementing an application agnostic framework device (AAFD) of the instant disclosure is illustrated.

According to exemplary embodiments, the above-described problems associated with conventional system may be overcome by implementing an AAFD 202 as illustrated in FIG. 2 to automatically allowing publication of location specific received information onto a display that may be customizable based location specific criteria for display.

The AAFD 202 may be the same or similar to the computer system 102 as described with respect to FIG. 1.

The AAFD 202 may store one or more applications that can include executable instructions that, when executed by the AAFD 202, cause the AAFD 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the AAFD 202 itself, may be located in virtual server(s) running in a cloud-based computing environment rather than being tied to one or more specific physical network computing devices. Also, the application(s) may be running in one or more virtual machines (VMs) executing on the AAFD 202. Additionally, in one or more embodiments of this technology, virtual machine(s) running on the AAFD 202 may be managed or supervised by a hypervisor.

In the network environment 200 of FIG. 2, the AAFD 202 is coupled to a plurality of server devices 204(1)-204(n) that hosts a plurality of databases 206(1)-206(n), and also to a plurality of client devices 208(1)-208(n) via communication network(s) 210. A communication interface of the AAFD 202, such as the network interface 114 of the computer system 102 of FIG. 1, operatively couples and communicates between the AAFD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the AAFD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 202 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The AAFD 202 may be a standalone device or integrated with one or more other devices or apparatuses, such as one or more of the server devices 204(1)-204(n), for example. In one particular example, the AAFD 202 may be hosted by one of the server devices 204(1)-204(n), and other arrangements are also possible. Moreover, one or more of the devices of the AAFD 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the AAFD 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the AAFD 202 that may be configured for automatically deactivating, upon detection of a disaster or a cyber scenario, protected authenticated emergency systems (i.e., critical systems) for a predetermined amount of time, but the disclosure is not limited thereto.

Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example.

The client devices 208(1)-208(n) may run interface applications, such as standard web browsers or standalone client applications, which may provide an interface to communicate with the AAFD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the AAFD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the AAFD 202, the server devices 204(1)-204(n), or the client devices 208(1)-208(n), for example, may be configured to operate as virtual instances on the same physical machine. For example, one or more of the AAFD 202, the server devices 204(1)-204(n), or the client devices 208(1)-208(n) may operate on the same physical device rather than as separate devices communicating through communication network(s) 210. Additionally, there may be more or fewer AAFDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

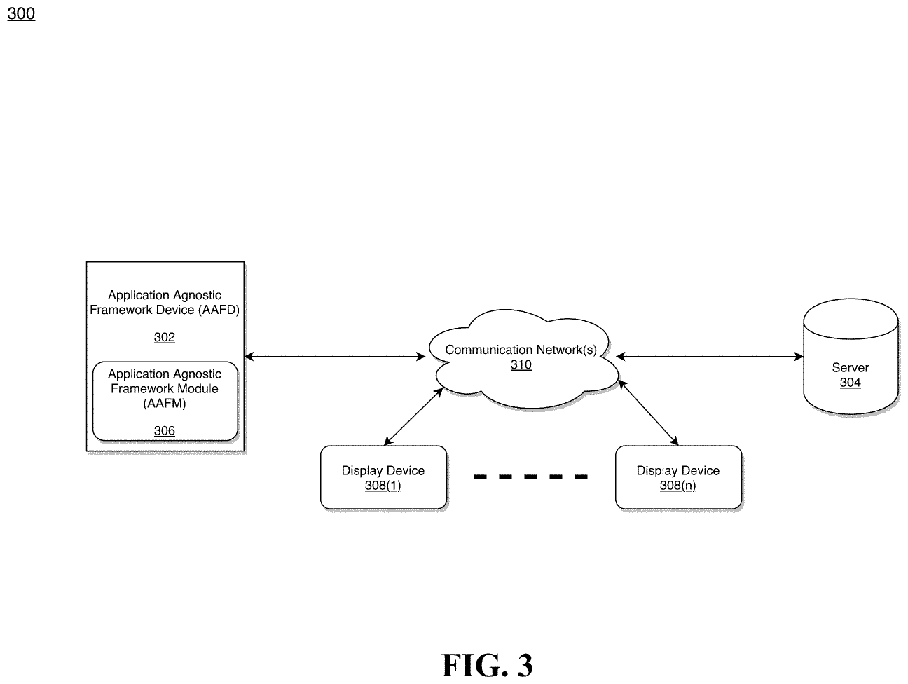

FIG. 3 illustrates a system diagram for implementing an application agnostic framework device (AAFD) having an application agnostic framework module (AAFM) in accordance with an exemplary embodiment.

As illustrated in FIG. 3, in the system 300, according to exemplary embodiments, the AAFD 302 having an AAFM 306 may be connected to a server 304 via a communication network 310, but the disclosure is not limited thereto.

According to exemplary embodiment, the AAFD 302 is described and shown in FIG. 3 as including the AAFM 306, although it may include other rules, policies, modules, databases, or applications, for example. According to exemplary embodiments, the server 304 may also be a database which may be configured to store information including the metadata, but the disclosure is not limited thereto. According to exemplary embodiments, the AAFM 306 may also be referred to as a processor.

According to exemplary embodiments, the AAFM 306 may also be configured to communicate with display devices 308(1)-308(n) via the communication network 310, but the disclosure is not limited thereto. According exemplary embodiments, the display devices 308(1)-308(n) may be televisions (TVs) located in various locations of a single building, or located in various locations of a plurality of buildings, or located in various cities, states, etc., but the disclosure is not limited thereto.

According to exemplary embodiments, each location's TV may be configured with a web-based application configured with an endpoint listener refreshing ONA (Organizational Network Analysis) data corresponding to the web-based application on a regular basis. A Raspberry Pi or a USB (universal serial bus) display device may be plugged into that TV configured to listen for the specific configured location (for example, 2 TVs, 1 in Chicago on the 28th floor in the NE corner of a building, 2nd in Tampa on the 3rd floor in the SW corner of a building, but the disclosure is not limited thereto). The web-based application may be configured to be connected to the endpoint for that location and refreshed regularly.

According to exemplary embodiments, the framework may be agnostic to the data passed—defining a generic schema that can publish any information needing a name, value, (or names and values), how a user wants it to be displayed, and in what location. Within the rules of that JSON schema—that information may be passed from whomever wants to publish information to the application. According to exemplary embodiments, the application listening for this data may interpret and render the data in a clean format passed based on the request which could be centrally hosted and pushed to this client or allowing full applications to be listened at each endpoint.

As will be described below, a plurality of display devices may be provided, each display device being configured with a web-based application configured with an endpoint listener, wherein each display device may be configured to listen for a specific configured location via corresponding endpoint listener. The AAFM 306 may be configured to receive location specific information of input data corresponding to the specific configured location, wherein the web-based application may connect to each endpoint listener for the specific configured location; define a schema for publishing information onto each display device based on the location specific information of input data; and display information onto each display device based on the defined schema, but the disclosure is not limited thereto.

According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the display devices 308(1)-308(n) may communicate with the AAFM 306 via broadband or cellular communication. Of course, these embodiments are merely exemplary and are not limiting or exhaustive.

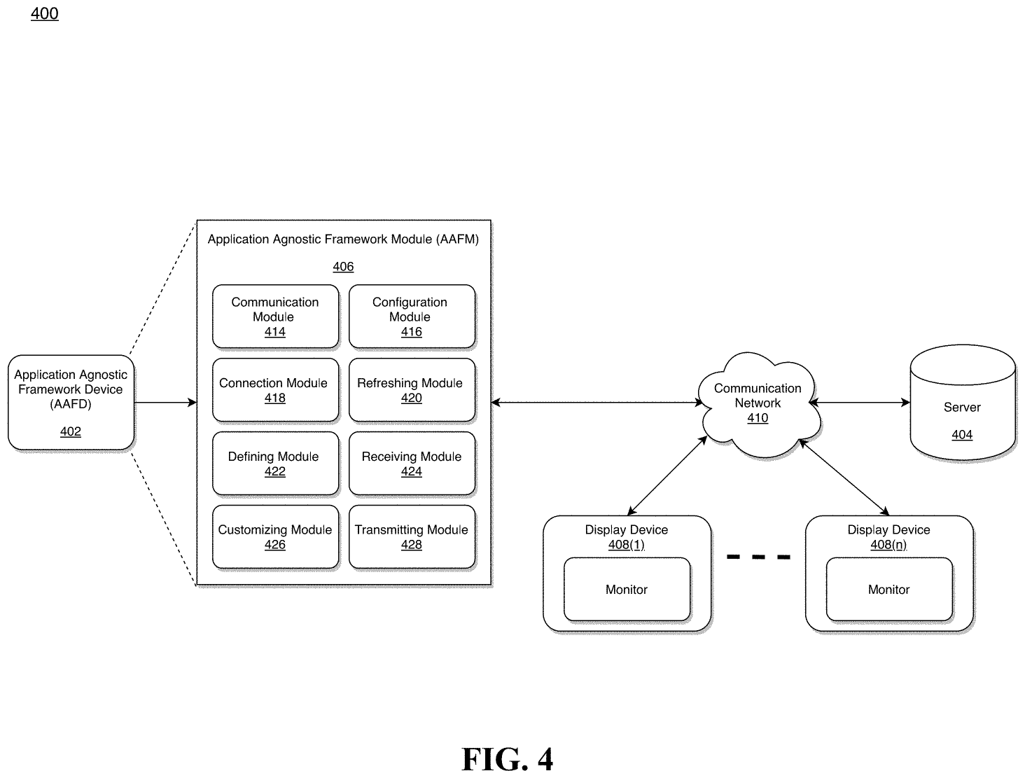

FIG. 4 illustrates a system diagram for implementing an application agnostic framework module (AAFM) of FIG. 3 in accordance with an exemplary embodiment. As illustrated in FIG. 4, the system 400 may include an AAFM 406, a server 404, a communication network 410, and one or more display devices 408(1)-408(n) that are subjected to the AAFM 406 for information display onto corresponding monitor.

According to exemplary embodiments, as illustrated in FIG. 4, the AAFM 406 may include a communication module 414, a configuration module 416, a connection module 418, a refreshing module 420, a defining module 422, a receiving module 424, a customizing module 428, and a transmitting module 428, but the disclosure is not limited thereto.

According to exemplary embodiments, the server 404 with reference to FIG. 4 may be same or similar to the server 304 as illustrated in FIG. 3, the display devices 408(1)-408(n) may be same or similar to the display devices 308(1)-308(n) as illustrated in FIG. 3, and the communication network 410 with reference to FIG. 4 may be same or similar to the communication network 310 as illustrated in FIG. 3.

According to exemplary embodiments, the AAFM 406 may include various systems that are managed and operated by an organization by utilizing user's devices.

Referring to FIG. 4, the process may be executed via the communication network 410 which may comprise plural networks as described above. For example, in an exemplary embodiment, the various components of the AAFM 406 may communicate with the server 304 and the display devices 408(1)-408(n) via the communication network 410 and the communication module 414. Of course, these embodiments are merely exemplary and are not limiting or exhaustive.

According to exemplary embodiments, each of the communication module 414, configuration module 416, connection module 418, refreshing module 420, defining module 422, receiving module 424, customizing module 428, and the transmitting module 428 of the AAFM 406 may be implemented by microprocessors or similar, they may be programmed using software (e.g., microcode) to perform various functions discussed herein. Alternatively, each of the communication module 414, configuration module 416, connection module 418, refreshing module 420, defining module 422, receiving module 424, customizing module 428, and the transmitting module 428 of the AAFM 406 may be implemented by dedicated hardware, or as a combination of dedicated hardware to perform some functions and a processor (e.g., one or more programmed microprocessors and associated circuitry) to perform various functions discussed herein as well as other functions. Also, according to exemplary embodiments, each of the communication module 414, configuration module 416, connection module 418, refreshing module 420, defining module 422, receiving module 424, customizing module 428, and the transmitting module 428 of the AAFM 406 may be physically separated into two or more interacting and discrete blocks, units, engines, devices, and/or modules without departing from the scope of the inventive concepts.

According to exemplary embodiments, the configuration module 416 may configure each display device (display devices 408(1)-408(n)) with a web-based application configured with an endpoint listener. Each endpoint listener may be an HTTP (Hypertext Transfer Protocol) listener where each virtual server (e.g., server 404) provides connections between the server 404 and clients through one or more HTTP listeners. Further, each HTTP listener may be a listen socket that has an IP address, a port number, a server name, and a default virtual server, but the disclosure is not limited thereto. According to exemplary embodiments, each display device (display devices 408(1)-408(n)) may be configured by the configuration module 416 to listen for a specific configured location via corresponding endpoint listener.

According to exemplary embodiments, the receiving module 424 may be configured to receive location specific information of input data corresponding to the specific configured location. The web-based application may connect via the connection module 418 to each endpoint listener for the specific configured location.

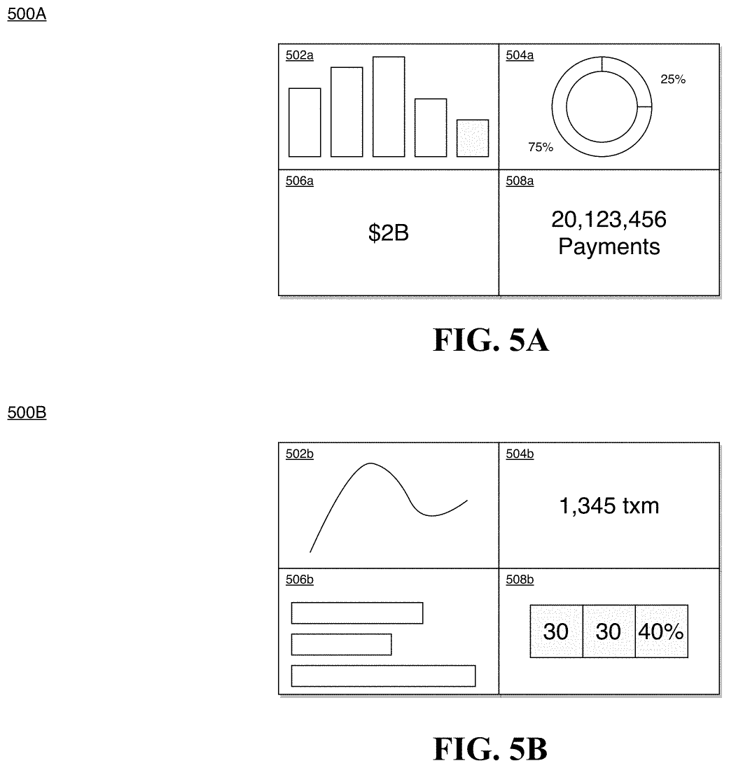

According to exemplary embodiments, the defining module 422 may be configured to define a schema for publishing information onto each display device (display devices 408(1)-408(n)) based on the location specific information of input data, AAFM 406 may be configured to display information onto each display device based on the defined schema. Exemplary displays are illustrated with reference to FIGS. 5A and 5B.

According to exemplary embodiments, the refreshing module 420 may be configured to refresh ONA (Organizational Network Analysis) data corresponding to the web-based application on a regular basis.

According to exemplary embodiments, the receiving module 424 may be configured to receive user's input to customize each endpoint listener based on location data of corresponding display device. The customization module 428 may be configured to customize each endpoint listener based on location data of corresponding display device.

According to exemplary embodiments, the displaying of information onto each display device 408(1)-408(n) based on the defined schema may include publishing information based on or more of the following data: a name data, a value data, a combination of a name and a value data, a desired display style or format data, a desired display location data, a data of desired display position onto a monitor of each display device in each display location.

According to exemplary embodiments, the framework executed by the AAFM 406 may be agnostic to the data being passed, wherein the schema may be a JSON schema, and within rules of the JSON schema, the publishing information may be transmitted by the transmitting module 428 from a user's computing device, who is requesting publication of the information onto a desired display device 408(1)-408(n), to the web-based application.

According to exemplary embodiments, the web-based application may include REST (Representational State Transfer)-based endpoints each configured to receive user's input for posting KPI (Key Performance Indicator) or relevant metrics for displaying information onto each display device 408(1)-408(n) based on the received user's input.

According to exemplary embodiments, the customizing module 426 may be configured to customize the endpoints based on the received location specific information of input data; and the transmitting module 428 may be configured to push the endpoints to the display device (one of 408(1)-408(n)) meeting the received location specific information of input data that is displaying the web-based application that consumes the metrics.

According to exemplary embodiments, the received location specific information of input data may be utilized as coordinates for the metrics.

According to exemplary embodiments, the connection module may be configured to connect a Raspberry Pi or a USB (Universal Serial Bus) device onto each display device 408(1)-408(n) configured to listen for the specific configured location via corresponding endpoint listener.

FIG. 5A illustrates an exemplary use case of the AAFM 406 in accordance with an exemplary embodiment. FIG. 5B illustrates another exemplary use case of the AAFM 406 in accordance with an exemplary embodiment.

As illustrated in FIGS. 5A and 5B, two locations of display devices (e.g., any two display devices among the display devices 408(1)-408(n)) are displaying contents, but the disclosure is not limited thereto. Any number of desired display devices among the display devices 408(1)-408(n) may be utilized.

As an example, a Raspberry Pi or USB display device may be plugged into a display device (e.g., a TV) configured to listen for the specific configured location (two TVs, one in Chicago on the 28th floor in the NE corner of a building), and another one in Tampa on the 3rd floor in the SW corner of a building, but the disclosure is not limited thereto). These may be used as coordinates for the metrics wanted to be displayed.

As an example, in FIG. 5A, the monitor 500A may display contents of the TV located in Chicago on the 28th floor in the NE corner of a building. A user may push, by utilizing the AAFM 406, a generalized http post with details of what the user would like and how the user would like to display in a specific location in Chicago. That information would be able to compile data and generate visuals in the format the user of the service desires. In this example, the information may include: posting location=28E, KPI name=ACH (automatic clearing house) payments, KPI value=20,000, KPI2name=ACH Payments yest, KPI2value=10,000,000, quadrant=Top Left, UIcomponent=high chart bar. Thus, quadrant 502a (which is the top left quadrant of monitor 500A) will display a high chart bar. Similarly, by customizing the information data based on user's desired criteria for display, contents may be displayed at other quadrants 504a, 506a, and 508a. Thus, the AAFM 406 may be configured to allow for visual cues on how the web-based application may be performing over the course of a day, publishing these messages with whatever frequency a user desires, and to locations that host development teams that are working on solutions that are supportive of these numbers.

As an example, in FIG. 5B, the monitor 500B may display contents of the TV located in Tampa on the 3rd floor in the SW corner of a building. A user may push, by utilizing the AAFM 406, a generalized http post with details of what the user would like and how the user would like to display in a specific location in Tampa. That information would be able to compile data and generate visuals in the format the user of the service desires. In this example, the information may include: posting location=28W, KPI name=ACH (automatic clearing house) payments, KPI value=20,000, KPI2name=ACH Payments yest, KPI2value=10,000,000, quadrant=Top Left, UIcomponent=line curve. Thus, quadrant 502b (which is the top left quadrant of monitor 500B) will display a line curve. Similarly, by customizing the information data based on user's desired criteria for display, contents may be displayed at other quadrants 504b, 506b, and 508b. Thus, the AAFM 406 may be configured to allow for visual cues on how the web-based application may be performing over the course of a day, publishing these messages with whatever frequency a user desires, and to locations that host development teams that are working on solutions that are supportive of these numbers.

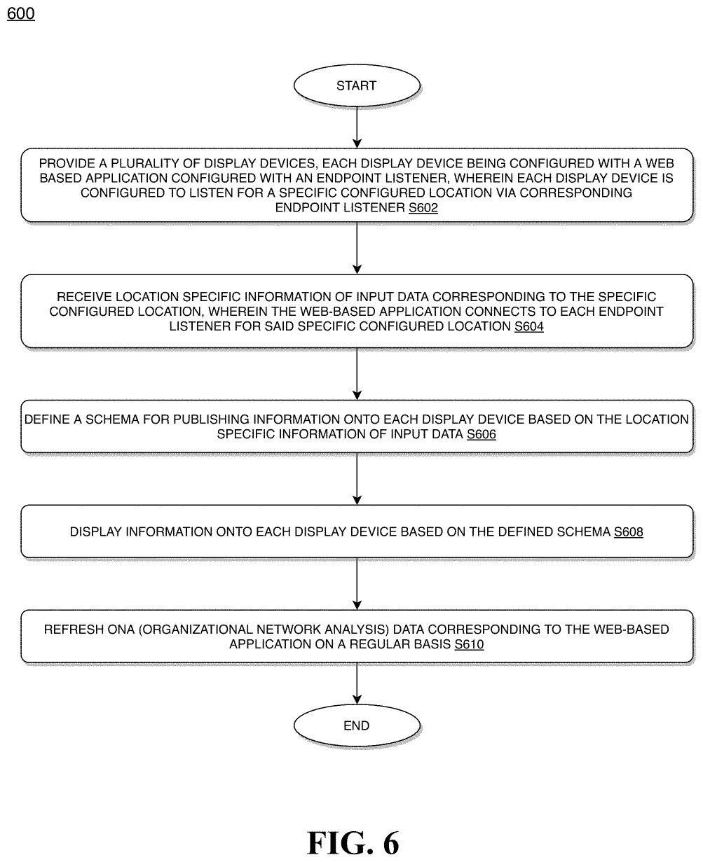

FIG. 6 illustrates a flow chart for implementing an application agnostic framework module in accordance with an exemplary embodiment.

It will be appreciated that the illustrated process 600 and associated steps may be performed in a different order, with illustrated steps omitted, with additional steps added, or with a combination of reordered, combined, omitted, or additional steps.

In the process 600 of FIG. 6, at step S602, a plurality of display devices may be provided, each display device being configured with a web-based application configured with an endpoint listener, wherein each display device is configured to listen for a specific configured location via corresponding endpoint listener.

According to exemplary embodiments, at step S604, location specific information of input data may be received corresponding to the specific configured location, wherein the web-based application connects to each endpoint listener for the specific configured location.

According to exemplary embodiments, at step S606, a schema may be defined for publishing information onto each display device based on the location specific information of input data.

According to exemplary embodiments, at step S608, information may be displayed onto each display device based on the defined schema.

According to exemplary embodiments, at step S610, ONA (Organizational Network Analysis) data corresponding to the web-based application may be refreshed on a regular basis. According to exemplary embodiments, the process 600 may connect a Raspberry Pi or a USB (Universal Serial Bus) device onto each display device configured to listen for the specific configured location via corresponding endpoint listener.

According to exemplary embodiments, the process 600 may further include: refreshing ONA (Organizational Network Analysis) data corresponding to the web-based application on a regular basis.

According to exemplary embodiments, the process 600 may further include: receiving user's input to customize each endpoint listener based on location data of corresponding display device.

According to exemplary embodiments, wherein the process 600 may further include displaying information onto each display device based on the defined schema comprises publishing information based on or more of the following data: a name data, a value data, a combination of a name and a value data, a desired display style or format data, a desired display location data, a data of desired display position onto a monitor of each display device in each display location, but the disclosure is not limited thereto.

According to exemplary embodiments, the process 600 may further include: providing a framework that is agnostic to the data being passed, wherein the schema is a JSON schema, and within rules of said JSON schema, transmitting the publishing information from a user's computing device, who is requesting publication of the information onto a desired display device, to the web-based application.

According to exemplary embodiments, the process 600 may further include: customizing the endpoints based on the received location specific information of input data; and pushing the endpoints to the display device meeting the received location specific information of input data that is displaying the web-based application that consumes the metrics.

According to exemplary embodiments, the process 600 may further include utilizing the received location specific information of input data as coordinates for the metrics.

According to exemplary embodiments, the process 600 may further include: connecting a Raspberry Pi or a USB (Universal Serial Bus) device onto each display device configured to listen for the specific configured location via corresponding endpoint listener.

According to exemplary embodiments, a non-transitory computer readable medium may be configured to store instructions for implementing the AAFM 406, but the disclosure is not limited thereto. According to exemplary embodiments, the instructions, when executed, may cause a processor embedded within the AAFM 406 to perform the following: configuring a plurality of display devices, each display device being configured with a web-based application configured with an endpoint listener, wherein each display device is configured to listen for a specific configured location via corresponding endpoint listener; receiving location specific information of input data corresponding to the specific configured location, wherein the web-based application connects to each endpoint listener for said specific configured location; defining a schema for publishing information onto each display device based on the location specific information of input data; and displaying information onto each display device based on the defined schema. The processor may be the same or similar to the processor 104 as illustrated in FIG. 1 or the processor embedded within AAFD 202, AAFD 302, AAFM 306, AAFD 402, and AAFM 406.

According to exemplary embodiments, the instructions, when executed, may further cause the processor 104 to perform the following: refreshing ONA (Organizational Network Analysis) data corresponding to the web-based application on a regular basis.

According to exemplary embodiments, the instructions, when executed, may further cause the processor 104 to perform the following: receiving user's input to customize each endpoint listener based on location data of corresponding display device.

According to exemplary embodiments, the instructions, when executed, may further cause the processor 104 to display information onto each display device based on the defined schema comprises publishing information based on or more of the following data: a name data, a value data, a combination of a name and a value data, a desired display style or format data, a desired display location data, a data of desired display position onto a monitor of each display device in each display location, but the disclosure is not limited thereto.

According to exemplary embodiments, the instructions, when executed, may further cause the processor 104 to perform the following: configuring a framework that is agnostic to the data being passed, wherein the schema is a JSON schema, and within rules of said JSON schema, transmitting the publishing information from a user's computing device, who is requesting publication of the information onto a desired display device, to the web-based application.

According to exemplary embodiments, the instructions, when executed, may further cause the processor 104 to perform the following: customizing the endpoints based on the received location specific information of input data; and pushing the endpoints to the display device meeting the received location specific information of input data that is displaying the web-based application that consumes the metrics.

According to exemplary embodiments, the instructions, when executed, may further cause the processor 104 to utilize the received location specific information of input data as coordinates for the metrics.

According to exemplary embodiments, the instructions, when executed, may further cause the processor 104 to perform the following: connecting a Raspberry Pi or a USB (Universal Serial Bus) device onto each display device configured to listen for the specific configured location via corresponding endpoint listener.

According to exemplary embodiments as disclosed above in FIGS. 1-6, technical improvements effected by the instant disclosure may include platforms for implementing an application agnostic framework module for identifying problematic behaviors or trends in an application through the use of location specific cloud-based visualizations in high performance workspaces, but the disclosure is not limited thereto. According to exemplary embodiments as disclosed above in FIGS. 1-6, technical improvements effected by the instant disclosure may further include platforms for implementing an application agnostic framework module that may allow publication of location specific received information onto a display that may be customizable based location specific criteria for display. According to exemplary embodiments as disclosed above in FIGS. 1-6, technical improvements effected by the instant disclosure may further include platforms for implementing an application agnostic framework module for a cloud-based application that includes REST (Representational State Transfer)-based end points where consumers may post KPI (Key Performance Indicator) or relevant metrics, thereby allowing visual cues on how the application may be performing over a course of a day, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for customizable display, the method comprising:
providing a plurality of display devices, each display device being configured with a web-based application configured with an endpoint listener, wherein each display device is configured to listen for a specific configured location via corresponding endpoint listener;
receiving location specific information of input data corresponding to the specific configured location, wherein the web-based application connects to each endpoint listener for said specific configured location;
defining a schema for publishing information onto each display device based on the location specific information of input data; and
displaying information onto each display device based on the defined schema.

2. The method according to claim 1, further comprising:
refreshing ONA (Organizational Network Analysis) data corresponding to the web-based application on a regular basis.

3. The method according to claim 1, further comprising:
receiving user's input to customize each endpoint listener based on location data of corresponding display device.

4. The method according to claim 1, wherein the displaying information onto each display device based on the defined schema comprises publishing information based on one or more of the following data: a name data, a value data, a combination of a name and a value data, a desired display style or format data, a desired display location data, a data of desired display position onto a monitor of each display device in each display location.

5. The method according to claim 4, further comprising:
providing a framework that is agnostic to the data being passed, wherein the schema is a JSON schema, and within rules of said JSON schema, the publishing information is transmitted from a user's computing device, who is requesting publication of the information onto a desired display device, to the web-based application.

6. The method according to claim 1, wherein the web-based application includes REST (Representational State Transfer)-based endpoints each configured to receive user's input for posting KPI (Key Performance Indicator) or relevant metrics for displaying information onto each display device based on the received user's input.

7. The method according to claim 6, further comprising:
customizing the endpoints based on the received location specific information of input data; and
pushing the endpoints to the display device meeting the received location specific information of input data that is displaying the web-based application that consumes the metrics.

8. The method according to claim 7, wherein the received location specific information of input data is utilized as coordinates for the metrics.

9. The method according to claim 1, further comprising:
connecting a Raspberry Pi or a USB (Universal Serial Bus) device onto each display device configured to listen for the specific configured location via corresponding endpoint listener.

10. A system for customizable display, comprising:
a processor;
a memory;
a plurality of display devices, each display device being configured with a web-based application configured with an endpoint listener, wherein each display device is configured to listen for a specific configured location via corresponding endpoint listener; and
a communication network coupled to each of the processor, the memory, and the plurality of display devices,
wherein the processor is configured to:
receive location specific information of input data corresponding to the specific configured location, wherein the web-based application connects to each endpoint listener for said specific configured location;
define a schema for publishing information onto each display device based on the location specific information of input data; and
display information onto each display device based on the defined schema.

11. The system according to claim 10, wherein the processor is further configured to:
refresh ONA (Organizational Network Analysis) data corresponding to the web-based application on a regular basis.

12. The system according to claim 10, wherein the processor is further configured to:
receive user's input to customize each endpoint listener based on location data of corresponding display device.

13. The system according to claim 10, wherein in displaying information onto each display device based on the defined schema, the processor is further configured to publish information based on one or more of the following data: a name data, a value data, a combination of a name and a value data, a desired display style or format data, a desired display location data, a data of desired display position onto a monitor of each display device in each display location.

14. The system according to claim 13, wherein the processor configures a framework that is agnostic to the data being passed, wherein the schema is a JSON schema, and within rules of said JSON schema, transmits the publishing information from a user's computing device, who is requesting publication of the information onto a desired display device, to the web-based application.

15. The system according to claim 10, wherein the web-based application includes REST (Representational State Transfer)-based endpoints each configured to receive user's input for posting KPI (Key Performance Indicator) or relevant metrics for displaying information onto each display device based on the received user's input.

16. The system according to claim 15, wherein the processor is further configured to:
customize the endpoints based on the received location specific information of input data; and
push the endpoints to the display device meeting the received location specific information of input data that is displaying the web-based application that consumes the metrics.

17. The system according to claim 16, wherein the processor is further configured to utilize the received location specific information of input data as coordinates for the metrics.

18. The system according to claim 10, wherein the processor is further configured to:
connect a Raspberry Pi or a USB (Universal Serial Bus) device onto each display device configured to listen for the specific configured location via corresponding endpoint listener.

19. A non-transitory computer readable medium configured to store instructions for implementing an application agnostic framework, wherein the instructions, when executed, cause a processor to perform the following:
configuring a plurality of display devices, each display device being configured with a web-based application configured with an endpoint listener, wherein each display device is configured to listen for a specific configured location via corresponding endpoint listener;
receiving location specific information of input data corresponding to the specific configured location, wherein the web-based application connects to each endpoint listener for said specific configured location;
defining a schema for publishing information onto each display device based on the location specific information of input data; and
displaying information onto each display device based on the defined schema.

20. The non-transitory computer readable medium according to claim 19, wherein the instructions, when executed, further cause the processor to perform the following: refreshing ONA (Organizational Network Analysis) data corresponding to the web-based application on a regular basis.
